(19) United States
(12) Patent Application Publication
(10) Pub. No.: US 2023/0175464 A1
(43) Pub. Date: Jun. 8, 2023

(54) EGR DEVICE

(71) Applicant: TOYOTA JIDOSHA KABUSHIKI KAISHA, Toyota-shi (JP)

(72) Inventor: Shigeki Miyashita, Susono-shi (JP)

(73) Assignee: TOYOTA JIDOSHA KABUSHIKI KAISHA, Toyota-shi (JP)

(21) Appl. No.: 18/072,952

(22) Filed: Dec. 1, 2022

(30) Foreign Application Priority Data
Dec. 2, 2021 (JP) 2021-196464

(51) Int. Cl. F02M 26/44; F02M 26/17

(52) U.S. Cl. CPC F02M 26/44; F02M 26/17

(57) ABSTRACT

An EGR device includes a plurality of EGR inlet pipes connected to each of the plurality of intake branch passages, an exhaust gas inlet passage conveying a portion of the exhaust gas as EGR gas, an upstream-side branch passage in communication with the exhaust gas inlet passage and branching the EGR gas, and a downstream-side branch passage distributing the EGR gas branched in the upstream-side branch passage to the plurality of EGR inlet pipes. The downstream-side branch passage extends in a direction parallel to an arrangement direction of the plurality of cylinders. At least one of the exhaust gas inlet passage and the upstream-side branch passage is configured to suppress flow to a downstream side of condensed water located upstream of the downstream-side branch passage when acceleration in a direction parallel to the arrangement direction is applied to the internal combustion engine.

### FIELD

The present disclosure relates to an EGR device.

### BACKGROUND

Conventionally, it is known to provide an EGR device for recirculating a part of the exhaust gas to the intake passage as EGR gas to an internal combustion engine. Patent Document 1 describes an EGR device configured to branch the EGR gas taken from the exhaust passage, and supply the branched EGR gas to each of the plurality of intake ports connected to the cylinders arranged in series horizontally.

### CITATIONS LIST

### Patent Literature

IPTL 1 Japanese Unexamined Patent Publication No. 2019-138247

### SUMMARY

### Technical Problem

When an internal combustion engine equipped with EGR device is exposed to a cold environment, the wall temperature of the EGR passage through which EGR gas flows is lowered, resulting in condensed water in the EGR passage. Condensed water stays in the EGR passage and moves in the EGR passage by the acceleration applied to the internal combustion engine when the vehicle runs.

In the configuration of the EGR device described in Patent Document 1, when an acceleration in a direction parallel to the arrangement direction of the cylinders is applied to the internal combustion engine, the condensed water in the EGR passage moves along the direction of the acceleration and flows into a particular cylinder (the cylinder at a far end). As a result, misfire due to condensed water may occur in a specific cylinder.

In view of the above problems, an object of the present disclosure is to provide an EGR device capable of preventing the condensed water accumulated in the EGR passage from flowing concentrated into a particular cylinder.

### Solution to Problem

The summary of the present disclosure is as follows.

(1) An EGR device provided in an internal combustion engine having a plurality of cylinders arranged in series in a horizontal direction and a plurality of intake branch passages connected to each of the plurality of cylinders, comprises a plurality of EGR inlet pipes connected to each of the plurality of intake branch passages; an exhaust gas inlet passage conveying a portion of the exhaust gas as EGR gas; an upstream-side branch passage in communication with the exhaust gas inlet passage and branching the EGR gas; and a downstream-side branch passage distributing the EGR gas branched in the upstream-side branch passage to the plurality of EGR inlet pipes, wherein the downstream-side branch passage extends in a direction parallel to an arrangement direction of the plurality of cylinders, and at least one of the exhaust gas inlet passage and the upstream-side branch passage is configured to suppress flow to a downstream side of condensed water located upstream of the downstream-side branch passage when acceleration in a direction parallel to the arrangement direction is applied to the internal combustion engine.

(2) The EGR device described in above (1), wherein the upstream-side branch passage comprises a first branch passage and a second branch passage, and the first branch passage and the second branch passage are configured so that the condensed water does not move between the first branch passage and the second branch passage when an acceleration in a direction parallel to the arrangement direction is applied to the internal combustion engine.

(3) The EGR device described in above (2), wherein the first branch passage and the second branch passage are separated by a partition wall.

(4) The EGR device described in above (2), wherein the upstream-side branch passage is divided into the first branch passage and the second branch passage at an upstream end of the upstream-side branch passage.

(5) The EGR device described in above (4), wherein the exhaust gas inlet passage extends from one side to an other side in a direction parallel to the arrangement direction from an upstream side toward a downstream side, the upstream-side branch passage, at the upstream end, is divided into the first branch passage and the second branch passage so that the first branch passage is positioned vertically upward and the second branch passage is positioned vertically downward, and the first branch passage extends from the one side to the other side from an upstream side toward a downstream side, and the second branch passage extends from the other side to the one side from an upstream side toward a downstream side.

(6) The EGR device described in above (5), wherein the upstream-side branch passage is divided into the first branch passage and the second branch passage at the upstream end such that a dividing line extends horizontally.

(7) The EGR device described in above (4), the exhaust gas inlet passage extends in a horizontal direction perpendicular to the arrangement direction, the upstream-side branch passage, at the upstream end, is divided into the first branch passage and the second branch passage so that the first branch passage is positioned on one side in a horizontal direction and the second branch passage is positioned on an other side in the horizontal direction, and the first branch passage extends from the one side to the other side from an upstream side toward a downstream side, and the second branch passage extends from the other side to the one side from an upstream side toward a downstream side.

(8) The EGR device described in above (7), wherein the upstream-side branch passage is divided into the first branch passage and the second branch passage at the upstream end such that a dividing line extends vertically.

(9) The EGR device described in any one of above (1) to (4), wherein the exhaust-gas inlet passage extends obliquely with respect to a horizontal direction perpendicular to the arrangement direction.

(10) The EGR device described in above (9), wherein the exhaust gas inlet passage extends obliquely from one side in a horizontal direction to the other side in the horizontal direction from an upstream side toward a downstream side, and the internal combustion engine is mounted on a vehicle so that in the internal combustion engine, acceleration from the one side to the other side is smaller than the acceleration from the other side to the one side when the vehicle is running.

(11) The EGR device described in above (9), wherein the internal combustion engine is mounted on the vehicle so that the arrangement direction coincides with a direction perpendicular to a vehicle width direction and the exhaust gas inlet passage extends inclined in a direction of acceleration applied to the internal combustion engine by acceleration of a vehicle from an upstream side toward a downstream side.

According to the present disclosure, there is provided an EGR device capable of preventing the condensed water accumulated in the EGR passage from flowing concentrated into a particular cylinder.

### BRIEF DESCRIPTION OF DRAWINGS

FIG. 1 is a diagram schematically showing an internal combustion engine provided with an EGR device according to a first embodiment of the present disclosure.

FIG. 2 is a diagram illustrating an internal combustion engine mounted on a vehicle so that the cylinder arrangement direction coincides with the vehicle width direction.

FIG. 3 is a diagram showing an internal combustion engine mounted on the vehicle so that the cylinder arrangement direction coincides with the vehicle front-rear direction.

FIG. 4 is a diagram schematically showing a configuration of an EGR device according to a second embodiment of the present disclosure.

FIG. 5 is a cross-sectional view of the upstream end of the upstream-side branch passage along line A-A in FIG. 4.

FIG. 6 is a diagram showing another divided shape of the upstream end of the upstream-side branch passage.

FIG. 7 is a diagram showing another divided shape of the upstream end of the upstream-side branch passage.

FIG. 8 is a diagram schematically showing a configuration of an EGR device according to a third embodiment of the present disclosure.

FIG. 9 is a cross-sectional view of the upstream end of the upstream-side branch passage along line B-B of FIG. 8.

FIG. 10 is a view showing another split shape of the upstream end of the upstream-side branch passage.

FIG. 11 is a view showing another split shape of the upstream end of the upstream-side branch passage.

FIG. 12 is a diagram schematically showing a configuration of an EGR device according to a fourth embodiment of the present disclosure.

FIG. 13 is a diagram showing an example of a mounting position of the internal combustion engine with respect to the vehicle.

FIG. 14 is a diagram illustrating another example of a mounting position of an internal combustion engine with respect to a vehicle.

### DESCRIPTION OF EMBODIMENTS

Hereinafter, embodiments of the present disclosure will be described in detail with reference to the drawings. In the following description, like components are denoted by the same reference numerals.

### First Embodiment

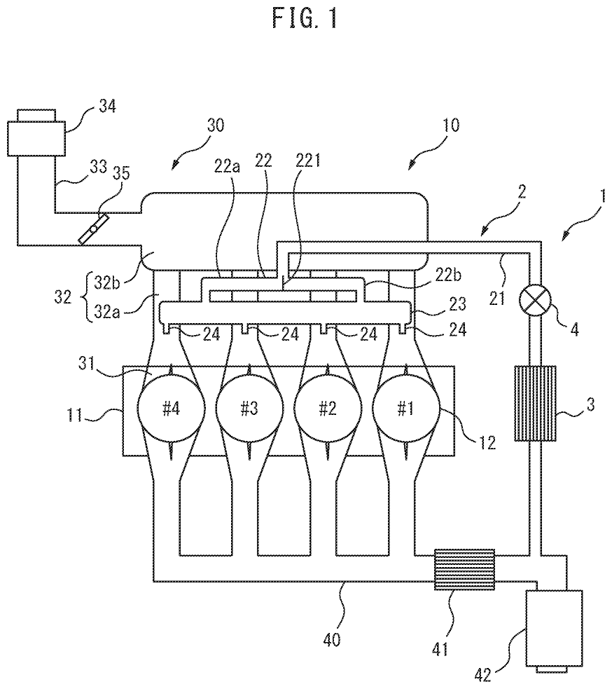

First, a first embodiment of the present disclosure will be described with reference to FIGS. 1 to 3.

FIG. 1 schematically shows an internal combustion engine 10 provided with an EGR device 1 according to a first embodiment of the present disclosure. In the present embodiment, the internal combustion engine 10 is a spark ignition type internal combustion engine, specifically, a gasoline engine fueled with gasoline. The internal combustion engine 10 is mounted on the vehicle and serves as a power source for the vehicle.

As shown in FIG. 1, the internal combustion engine 10 has an engine body 11, an intake passage 30 and an exhaust passage 40. A plurality of cylinders 12 arranged in series in the horizontal direction are formed in the engine body 11. In the present embodiment, the internal combustion engine 10 is a series four-cylinder engine, and the plurality of cylinders 12 consist of four cylinders #1 to #4.

The intake passage 30 takes in air around the internal combustion engine 10 and directs air into the plurality of cylinders 12. The intake passage 30 includes a plurality of intake ports 31, an intake manifold 32, and an intake pipe 33. The plurality of intake ports 31 are connected to each of the plurality of cylinders 12 and are opened and closed by intake valves (not shown).

The intake port 31 is an example of an intake branch passage.

Intake manifold 32 includes a plurality of branch portions 32a connected to each of the plurality of intake ports 31, and a collecting portion (surge tank) 32b along which these branch portions 32a are arranged. The branch portion 32a of the intake manifold 32 is connected to the cylinder 12 via an intake port 31. The branch 32a of the intake manifold 32 is another example of an intake branch passage.

The surge tank 32b is connected to an intake pipe 33, and the intake pipe 33 is connected to an air cleaner 34. Throttle valve 35 is disposed in the intake pipe 33 between the air cleaner 34 and the surge tank 32b. Throttle valve 35 changes the opening area of the intake pipe 33 in accordance with an opening position, to adjust the suction air amount.

Exhaust passage 40 is connected to each of the plurality of cylinders 12, to discharge the exhaust gas generated in the cylinder 12 by the combustion of a mixture of air and fuel to the outside of the vehicle. An exhaust purification catalyst 41 and a muffler 42 are disposed in the exhaust passage 40.

The EGR device 1 recirculates a portion of the exhaust gas flowing through the exhaust passage 40 to the intake passage 30 as EGR gas. The EGR device 1 comprises an EGR passage 2, an EGR cooler 3 and an EGR valve 4.

The EGR passage 2 connects the intake passage 30 and the exhaust passage 40, and the EGR gas flows through the EGR passage 2 into the intake passage 30. The EGR cooler 3 is disposed around the EGR passage 2 to cool the EGR gas flowing through the EGR passage 2.

The EGR valve 4 is disposed in the EGR passage 2 on the downstream side of the EGR cooler 3, to adjust the amount of EGR gas flowing through the EGR passage 2.

In the present embodiment, the EGR passage 2 includes an exhaust gas inlet passage 21, an upstream-side branch passage 22, a downstream-side branch passage 23, and a plurality of EGR inlet pipes 24. The exhaust gas inlet passage 21, the upstream-side branch passage 22, the downstream-side branch passage 23 and a plurality of EGR inlet pipes 24, respectively, extend in the horizontal direction.

One end of the exhaust gas inlet passage 21 (upstream end) is connected to the exhaust passage 40 between the exhaust purification catalyst 41 and the muffler 42, and the other end of the exhaust gas inlet passage 21 (downstream end) is connected to the upstream-side branch passage 22. That is, the exhaust gas inlet passage 21 communicates with the exhaust passage 40 and the upstream-side branch passage 22. The exhaust gas inlet passage 21 may be connected to another position of the exhaust passage 40, for example, the exhaust passage 40 on the upstream side of the exhaust purification catalyst 41.

The exhaust gas inlet passage 21 takes in a portion of the exhaust gas flowing through the exhaust passage 40 as EGR gas. The EGR cooler 3 and the EGR valve 4 described above are disposed in the exhaust gas inlet passage 21, and the EGR gas passes through the EGR cooler 3 and the EGR valve 4 in the exhaust gas inlet passage 21. The downstream portion of the exhaust gas inlet passage 21, in this embodiment, the portion downstream of the EGR valve 4 of the exhaust gas inlet passage 21, extends in a direction parallel to the arrangement direction of the plurality of cylinders 12 and is connected to the upstream-side branch passage 22.

One end of the upstream-side branch passage 22 (upstream end) is connected to the exhaust gas inlet passage 21, the other end of the upstream-side branch passage 22 (downstream end) is connected to the downstream-side branch passage 23. That is, the upstream-side branch passage 22 communicates with the exhaust gas inlet passage 21 and the downstream-side branch passage 23.

The upstream-side branch passage 22 extends in a direction parallel to the arrangement direction of the plurality of cylinders 12, and branches the EGR gas flowing from the exhaust gas inlet passage 21. In the present embodiment, the upstream-side branch passage 22 is composed of a first branch passage 22a and a second branch passage 22b, and branches the EGR gas in the direction of the first branch passage 22a and the direction of the second branch passage 22b. That is, the upstream-side branch passage 22 branches the EGR gas into two.

The first branch passage 22a and the second branch passage 22b, in the arrangement direction of the plurality of cylinders 12, extend in opposite directions to each other. That is, the first branch passage 22a extends in one direction parallel to the arrangement direction of the plurality of cylinders 12 (from right to left in FIG. 1), and the second branch passage 22b extends in the other direction parallel to the arrangement direction of the plurality of cylinders 12 (from left to right in FIG. 1). Therefore, the EGR gas flowing into the first branch passage 22a from the exhaust gas inlet passage 21, and the EGR gas flowing into the second branch passage 22b from the exhaust gas inlet passage 21 flow in directions opposite to each other.

One end of the downstream-side branch passage 23 (upstream end) is connected to the upstream-side branch passage 22, and the other end of the downstream-side branch passage 23 (downstream end) is connected to each of the plurality of EGR inlet pipes 24. That is, the downstream-side branch passage 23 communicates with the upstream-side branch passage 22 and the EGR inlet pipe 24.

The downstream-side branch passage 23 extends in a direction parallel to the arrangement direction of the plurality of cylinders 12, and distributes the EGR gas branched in the upstream-side branch passage 22 to a plurality of EGR inlet pipes 24. In the present embodiment, the downstream-side branch passage 23 distributes the EGR gas which is divided into two in the upstream-side branch passage 22 to the four EGR inlet pipes 24.

One end of the EGR inlet pipe 24 (upstream end) is connected to the downstream-side branch passage 23, and the other end of the EGR inlet pipe 24 (downstream end) is connected to the branch portion 32a of the intake manifold 32. That is, a plurality of EGR inlet pipes 24, respectively, communicate with the branch portion 32a of the downstream-side branch passage 23 and the intake manifold 32. Note that, a plurality of EGR inlet pipes 24, instead of being connected to each of the plurality of branch portions 32a of the intake manifold 32, may be connected to each of the plurality of intake ports 31.

The plurality of EGR inlet pipes 24 extend in a horizontal direction perpendicular to the arrangement direction of the plurality of cylinders 12, and recirculate the EGR gas distributed from the downstream-side branch passage 23 to the intake passage 30. The EGR gas recirculated to the intake passage 30 flows into each of the plurality of cylinders 12 together with the air supplied from the intake pipe 33. In the present embodiment, the EGR gas flowing from the first branch passage 22a of the upstream-side branch passage 22 into the downstream-side branch passage 23 is supplied to the first cylinder #1 and the second cylinder #2 through the two EGR inlet pipes 24, while the EGR gas flowing from the second branch passage 22b of the upstream-side branch passage 22 into the downstream-side branch passage 23 is supplied to the third cylinder #3 and the fourth cylinder #4 through the two EGR inlet pipes 24.

Incidentally, when the internal combustion engine 10 provided with the EGR device 1 is exposed to a cold environment, the wall temperature of the EGR passage 2 is reduced, and condensed water is generated from the EGR gas in the EGR passage 2. Condensed water stays in the EGR passage 2 and moves in the EGR passage 2 by the acceleration applied to the internal combustion engine 10 when the vehicle is running.

As described above, the downstream portion of the exhaust gas inlet passage 21, the upstream-side branch passage 22 and the downstream-side branch passage 23, respectively, extend in a direction parallel to the arrangement direction of the plurality of cylinders 12 (hereinafter, referred to as “cylinder arrangement direction”). Therefore, when the acceleration in the direction parallel to the cylinder arrangement direction is applied to the internal combustion engine 10, the movement of the condensed water is promoted in each passage.

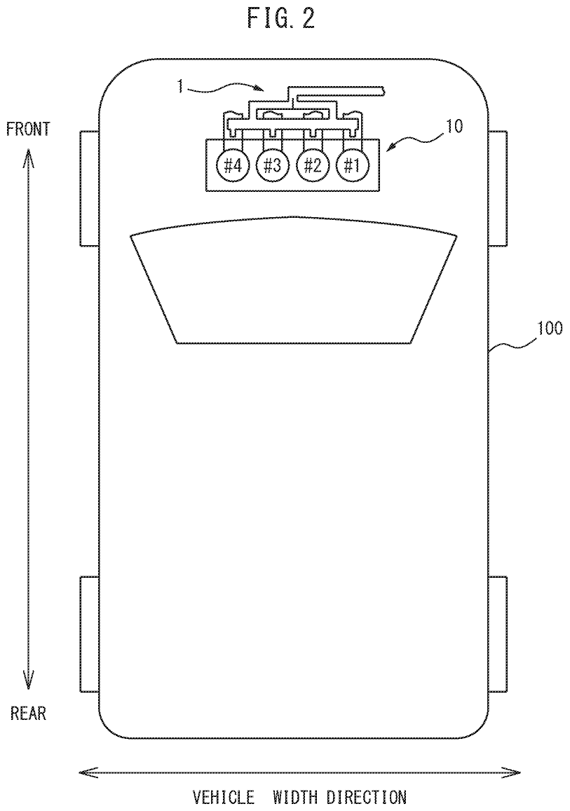

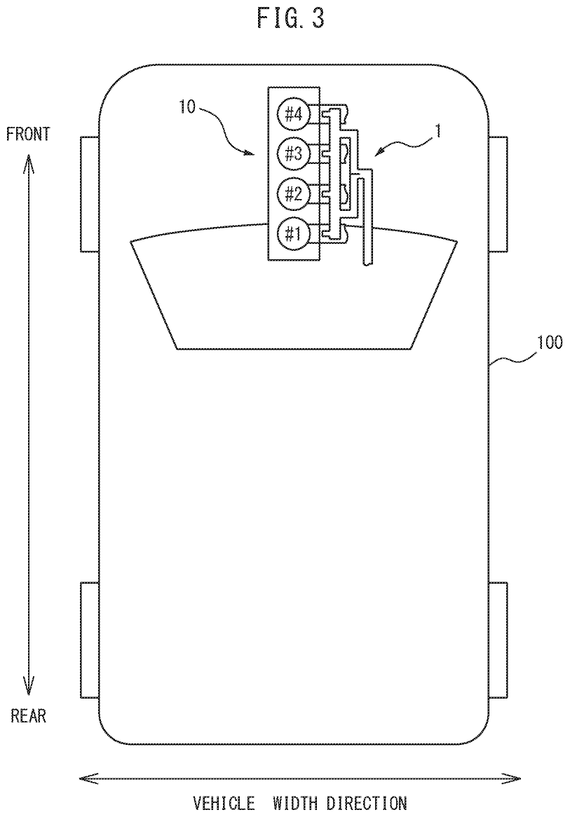

For example, as shown in FIG. 2, when the internal combustion engine 10 is mounted on the vehicle 100 so that the cylinder arrangement direction coincides with the vehicle width direction, the movement of the condensed water is promoted by the acceleration in the lateral direction applied to the internal combustion engine 10. The acceleration in the left direction occurs when the vehicle 100 turns to the right or when the vehicle 100 is traveling on a road with a left downward slope, while the acceleration in the right direction occurs when the vehicle 100 turns to the left or when the vehicle 100 is traveling on a road with a right downward slope. On the other hand, as shown in FIG. 3, when the internal combustion engine 10 is mounted on the vehicle 100 so that the cylinder arrangement direction coincides with the direction perpendicular to the vehicle width direction (the vehicle front-rear direction), the movement of the condensed water is promoted by the acceleration in the front-rear direction. Forward acceleration occurs when the vehicle 100 decelerates or the vehicle 100 is traveling on a downhill road, while rearward acceleration occurs when the vehicle 100 accelerates or the vehicle 100 is traveling on an uphill road.

Therefore, in FIG. 1, when the acceleration in the left direction is applied to the internal combustion engine 10, the movement of the condensate water from right to left in the EGR passage 2 is promoted, and the condensed water in the EGR passage 2 is easily flowed into the fourth cylinder #4. On the other hand, in FIG. 1, when the acceleration in the right direction is applied to the internal combustion engine 10, the movement of the condensate water from left to right in the EGR passage 2 is promoted, and the condensed water in the EGR passage 2 is easily flowed into the first cylinder #1.

In contrast, in the present embodiment, the upstream-side branch passage 22 is configured to suppress the flow to the downstream side of the condensed water located upstream of the downstream-side branch passage 23 when the acceleration in a direction parallel to the cylinder arrangement direction is applied to the internal combustion engine 10. Specifically, as shown in FIG. 1, the first branch passage 22a and the second branch passage 22b of the upstream-side branch passage 22 are separated by the partition wall 221, and the movement of the condensed water between the first branch passage 22a and the second branch passage 22b is prevented by the partition wall 221. That is, the first branch passage 22a and the second branch passage 22b are configured so that the condensed water does not move between the first branch passage 22a and the second branch passage 22b when the acceleration in a direction parallel to the cylinder arrangement direction is applied to the internal combustion engine 10.

Therefore, even if the acceleration in the left direction in FIG. 1 is applied to the internal combustion engine 10, the movement of the condensed water from the second branch passage 22b to the first branch passage 22a is prevented. As a result, it is possible to prevent the condensate water flowing into the second branch passage 22b from the exhaust gas inlet passage 21 and the condensed water generated in the second branch passage 22b from flowing into the fourth cylinder #4. Further, even if the acceleration in the right direction in FIG. 1 is applied to the internal combustion engine 10, the movement of the condensed water from the first branch passage 22a to the second branch passage 22b is prevented. As a result, it is possible to prevent the condensate water flowing into the first branch passage 22a from the exhaust gas inlet passage 21 and the condensed water generated in the first branch passage 22a from flowing into the first cylinder #1. Therefore, according to the present embodiment, it is possible to suppress the condensed water accumulated in the EGR passage 2 from flowing concentrated into a specific cylinder.

Note that, although the exhaust gas inlet passage 21 in FIG. 1 extends in a direction parallel to the cylinder arrangement direction, it may extend in other directions. For example, the exhaust gas inlet passage 21 may extend in a horizontal direction perpendicular to the cylinder arrangement direction or may extend inclined with respect to a horizontal direction perpendicular to the cylinder arrangement direction.

### Second Embodiment

The configuration of the EGR device according to the second embodiment is basically the same as the configuration of the EGR device according to the first embodiment, except for the following points. Therefore, the second embodiment of the present disclosure will be described below focusing on portions different from the first embodiment.

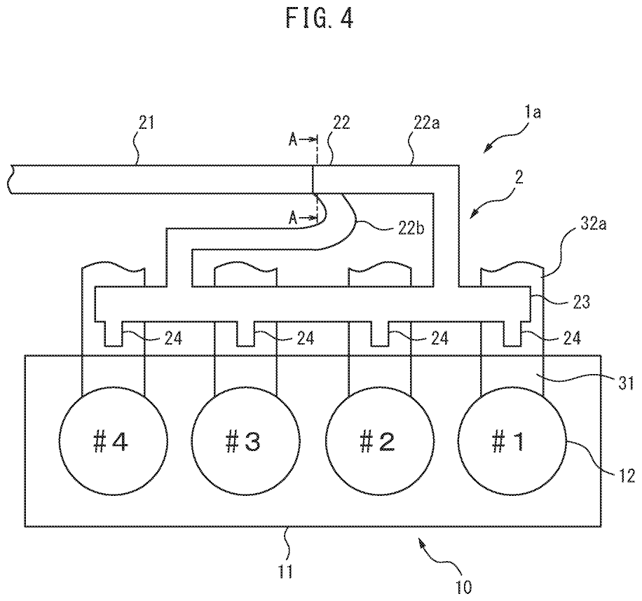

FIG. 4 is a diagram schematically showing a configuration of an EGR device 1a according to a second embodiment of the present disclosure. Similar to the first embodiment, the EGR device 1a includes an EGR passage 2, and the EGR passage 2 includes an exhaust gas inlet passage 21, an upstream-side branch passage 22, a downstream-side branch passage 23, and a plurality of EGR inlet pipes 24.

As shown in FIG. 4, the exhaust gas inlet passage 21 extends in a direction parallel to the cylinder arrangement direction and is connected to the upstream-side branch passage 22. In the second embodiment, the upstream-side branch passage 22 is divided into a first branch passage 22a and a second branch passage 22b at the upstream end thereof. That is, the first branch passage 22a and the second branch passage 22b are configured so that the condensed water does not move between the first branch passage 22a and the second branch passage 22b when the acceleration in a direction parallel to the cylinder arrangement direction is applied to the internal combustion engine 10. Thus, similarly to the first embodiment, it is possible to suppress the condensed water accumulated in the EGR passage 2 from flowing concentrated into a specific cylinder.

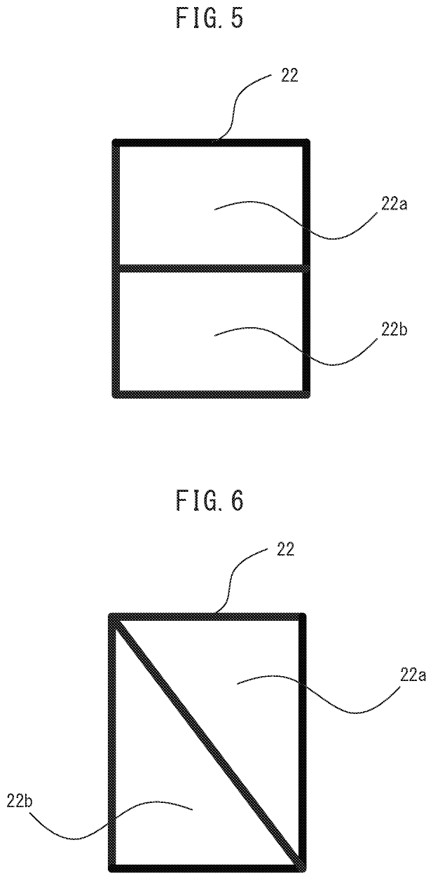

Specifically, the upstream-side branch passage 22, at its upstream end, is divided into a first branch passage 22a and the second branch passage 22b so that the first branch passage 22a is positioned vertically upward and the second branch passage 22b is positioned vertically downward. FIG. 5 is a cross-sectional view of the upstream end of the upstream-side branch passage 22 along line A-A in FIG. 4. In the example of FIG. 5, the upstream-side branch passage 22, at its upstream end, is divided into a first branch passage 22a and a second branch passage 22b so that the division line extends in the horizontal direction, the first branch passage 22a is disposed vertically upward, and the second branch passage 22b is disposed vertically downward.

Further, as shown in FIG. 4, the first branch passage 22a extends from the left side to the right side in a direction parallel to the cylinder arrangement direction toward the downstream side from the upstream side. That is, the first branch passage 22a extends in the same direction as the exhaust gas inlet passage 21 in a direction parallel to the cylinder arrangement direction. On the other hand, the second branch passage 22b extends from the right side to the left side in a direction parallel to the cylinder arrangement direction from the upstream side toward the downstream side. That is, the second branch passage 22b extends in a direction opposite to the exhaust gas inlet passage 21 and the first branch passage 22a in a direction parallel to the cylinder arrangement direction.

As described above, the condensed water accumulated in the EGR passage 2 moves in the EGR passage 2 by the acceleration applied to the internal combustion engine 10. As shown in FIG. 4, the exhaust gas inlet passage 21 extends from the left side to the right side in a direction parallel to the cylinder arrangement direction from the upstream side toward the downstream side.

Therefore, when the acceleration in the right direction in FIG. 4 is applied to the internal combustion engine 10, the condensate water in the exhaust gas inlet passage 21 moves from left to right, and the inflow of condensed water from the exhaust gas inlet passage 21 to the upstream-side branch passage 22 is promoted. By the action of gravity, the amount of condensate water flowing into the second branch passage 22b located vertically downward becomes more than the amount of condensed water flowing into the first branch passage 22a located vertically upward.

In the first branch passage 22a extending from the left side to the right side, the inflow of the condensed water in the first branch passage 22a to the downstream-side branch passage 23 is promoted by the acceleration in the right direction. On the other hand, in the second branch passage 22b extending from the right side to the left side, the inflow of the condensed water in the second branch passage 22b to the downstream-side branch passage 23 is suppressed by the acceleration in the right direction. Further, in the downstream-side branch passage 23, the inflow of the condensed water in the downstream-side branch passage 23 to the first cylinder #1 is promoted by the acceleration in the right direction.

Therefore, according to the configuration of EGR device 1a, when the acceleration in the right direction is applied to the internal combustion engine 10, the inflow of the condensed water located in the exhaust gas inlet passage 21 and the second branch passage 22b to the first cylinder #1 is suppressed. Therefore, as compared with the case where most of the condensate water in the exhaust gas inlet passage 21 and the upstream-side branch passage 22 by the acceleration in the right direction flows into the first cylinder #1, the condensed water accumulated in the EGR passage 2 can be suppressed from flowing concentrated into a specific cylinder.

On the other hand, when the acceleration in the left direction is applied to the internal combustion engine 10 in FIG. 4, the condensate water in the exhaust gas inlet passage 21 moves from right to left, and the inflow of the condensed water from the exhaust gas inlet passage 21 to the upstream-side branch passage 22 is suppressed. In the first branch passage 22a extending from the left side to the right side, the inflow of the condensate water in the first branch passage 22a to the downstream-side branch passage 23 is suppressed by the acceleration in the left direction, and in the second branch passage 22b extending from the right side to the left side, by the acceleration in the left direction, inflow to the downstream-side branch passage 23 of the condensed water in the second branch passage 22b is promoted. Further, in the downstream-side branch passage 23, the inflow to the fourth cylinder #4 of the condensed water in the downstream-side branch passage 23 is promoted by the acceleration in the left direction.

Therefore, according to the configuration of the EGR device 1a, when the leftward acceleration is applied to the internal combustion engine 10, the flow into the fourth cylinder #4 of the condensed water located in the first branch passage 22a as well as the exhaust gas inlet passage 21 is suppressed. Therefore, as compared with the case where most of the condensate water in the upstream-side branch passage 22 flows into the fourth cylinder #4 by the acceleration in the left direction, it is possible to suppress the condensed water accumulated in the EGR passage 2 from flowing concentrated into a specific cylinder.

Note that, the exhaust gas inlet passage 21 may extend from the right side to the left side in a direction parallel to the cylinder arrangement direction from the upstream side toward the downstream side. In this case, the first branch passage 22a located on the vertical direction upper side extends from the right side to the left side in a direction parallel to the cylinder arrangement direction from the upstream side toward the downstream side, and the second branch passage 22b located on the vertical direction lower side extends from the left side to the right side in a direction parallel to the cylinder arrangement direction from the upstream side toward the downstream side. Thus, when the acceleration in the left direction is applied to the internal combustion engine 10, it is possible to suppress the inflow to the fourth cylinder #4 of the condensed water located in the exhaust gas inlet passage 21 and the second branch passage 22b.

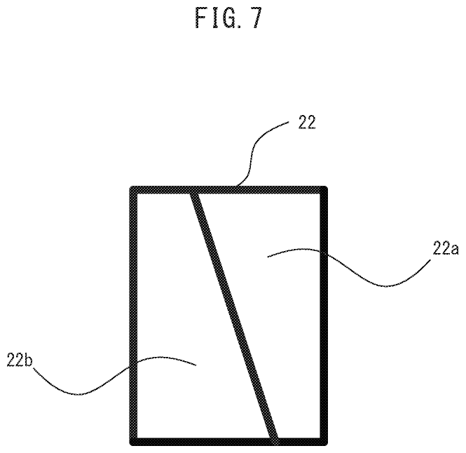

Further, so long as the first branch passage 22a is positioned vertically upward and the second branch passage 22b is positioned vertically downward, the upstream-side branch passage 22 may be divided into other shapes at its upstream end. For example, as shown in FIGS. 6 and 7, the upstream-side branch passage 22, may be divided into a first branch passage 22a and a second branch passage 22b at its upstream end so that the dividing line extends obliquely with respect to the vertical direction.

### Third Embodiment

The configuration of the EGR device according to the third embodiment is basically the same as the configuration of the EGR device according to the first embodiment, except for the following points. Therefore, the third embodiment of the present disclosure will be described below focusing on portions different from the first embodiment.

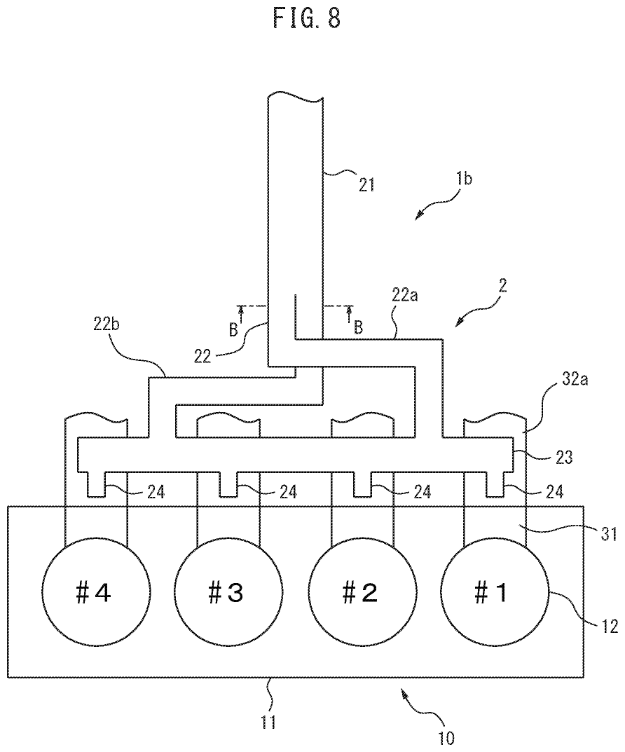

FIG. 8 is a diagram schematically showing a configuration of an EGR device 1b according to a third embodiment of the present disclosure. Similar to the first embodiment, the EGR device 1b includes an EGR passage 2, and the EGR passage 2 includes an exhaust gas inlet passage 21, an upstream-side branch passage 22, a downstream-side branch passage 23, and a plurality of EGR inlet pipes 24.

As shown in FIG. 8, the exhaust gas inlet passage 21 extends in a horizontal direction perpendicular to the cylinder arrangement direction and is connected to the upstream-side branch passage 22. In the third embodiment, the upstream-side branch passage 22 is divided into a first branch passage 22a and a second branch passage 22b at the upstream end thereof. That is, the first branch passage 22a and the second branch passage 22b are configured so that the condensed water does not move between the first branch passage 22a and the second branch passage 22b when the acceleration in a direction parallel to the cylinder arrangement direction is applied to the internal combustion engine 10. Thus, similar to the first embodiment, it is possible to suppress the condensed water accumulated in the EGR passage 2 from flowing concentrated into a specific cylinder.

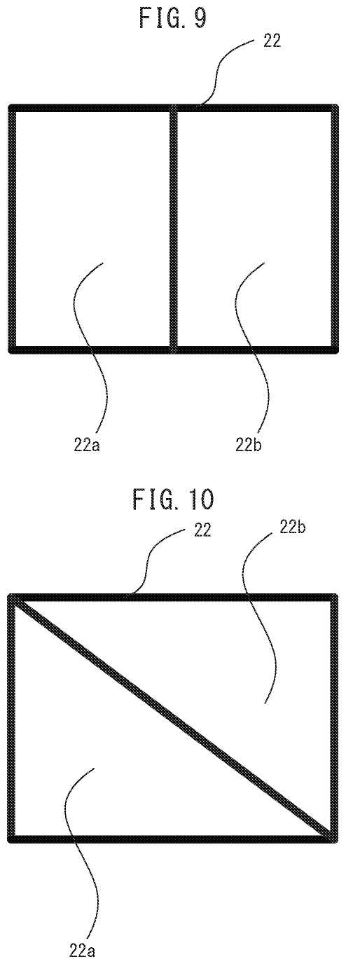

Specifically, the upstream-side branch passage 22, at its upstream end, is divided into a first branch passage 22a and the second branch passage 22b so that the first branch passage 22a is positioned on one side in the horizontal direction and the second branch passage 22b is positioned on the other side in the horizontal direction. FIG. 9 is a cross-sectional view of the upstream end of the upstream-side branch passage 22 along line B-B of FIG. 8. In the example of FIG. 9, the upstream-side branch passage 22, at its upstream end, is divided into a first branch passage 22a and a second branch passage 22b so that the division line extends in the vertical direction. The first branch passage 22a is disposed on the left side in the horizontal direction, and the second branch passage 22b is disposed on the right side in the horizontal direction. Further, as shown in FIG. 8, the first branch passage 22a extends from the horizontal direction left side to the horizontal direction right side from the upstream side toward the downstream side, while the second branch passage 22b extends from the horizontal direction right side to the horizontal direction left side from the upstream side toward the downstream side.

As described above, the condensed water accumulated in the EGR passage 2 moves in the EGR passage 2 by the acceleration applied to the internal combustion engine 10. If the acceleration in the right direction in FIG. 8 is applied to the internal combustion engine 10, the condensed water in the exhaust gas inlet passage 21 moves from left to right. Therefore, the amount of condensate water flowing from the exhaust gas inlet passage 21 to the second branch passage 22b located on the horizontal right side becomes more than the amount of condensed water flowing from the exhaust gas inlet passage 21 to the first branch passage 22a located on the horizontal left side.

In the first branch passage 22a extending from the horizontal left side to the horizontal direction right side, the inflow of the condensed water in the first branch passage 22a to the downstream-side branch passage 23 is promoted by the acceleration in the right direction. On the other hand, in the second branch passage 22b extending from the horizontal direction right side to the horizontal direction left side, the inflow of the condensed water in the second branch passage 22b to the downstream-side branch passage 23 is suppressed by the acceleration in the right direction. Further, in the downstream-side branch passage 23, the inflow of the condensed water in the downstream-side branch passage 23 to the first cylinder #1 is promoted by the acceleration in the right direction.

Therefore, according to the configuration of the EGR device 1b, when the right direction acceleration is applied to the internal combustion engine 10, the inflow of the condensed water located in the exhaust gas inlet passage 21 and the second branch passage 22b to the first cylinder #1 is suppressed. Therefore, as compared with the case where most of the condensate water in the exhaust gas inlet passage 21 and the upstream-side branch passage 22 by the acceleration in the right direction flows into the first cylinder #1, the condensed water accumulated in the EGR passage 2 can be suppressed from flowing concentrated into a specific cylinder.

On the other hand, when the acceleration in the left direction in FIG. 8 is applied to the internal combustion engine 10, the condensed water in the exhaust gas inlet passage 21 moves from right to left. Therefore, the amount of condensate water flowing from the exhaust gas inlet passage 21 to the first branch passage 22a located on the horizontal left side becomes more than the amount of condensed water flowing from the exhaust gas inlet passage 21 to the second branch passage 22b located on the horizontal right side.

In the second branch passage 22b extending from the horizontal right side to the horizontal direction left side, the inflow of the condensed water in the second branch passage 22b to the downstream-side branch passage 23 is promoted by the acceleration in the left direction. On the other hand, in the first branch passage 22a extending from the horizontal left side to the horizontal direction right side, the inflow of the condensed water in the first branch passage 22a to the downstream-side branch passage 23 is suppressed by the acceleration in the left direction. Further, in the downstream-side branch passage 23, the inflow to the fourth cylinder #4 of the condensed water in the downstream-side branch passage 23 by the acceleration in the left direction is promoted.

Therefore, according to the configuration of the EGR device 1b, when the left direction acceleration is applied to the internal combustion engine 10, the inflow to the fourth cylinder #4 of the condensed water located in the exhaust gas inlet passage 21 and the first branch passage 22a is suppressed. Therefore, as compared with the case where most of the condensate water in the exhaust gas inlet passage 21 and the upstream-side branch passage 22 by the acceleration in the left direction flows into the fourth cylinder #4, it is possible to suppress the condensed water accumulated in the EGR passage 2 from flowing concentrated into a specific cylinder.

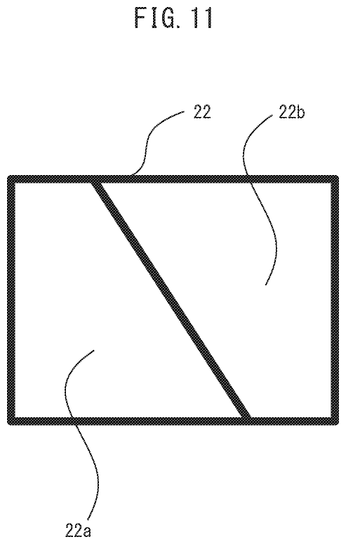

Note that, so long as the first branch passage 22a is positioned on one side of the horizontal direction and the second branch passage 22b is positioned on the other side of the horizontal direction, the upstream-side branch passage 22 may be divided into other shapes at its upstream end. For example, as shown in FIGS. 10 and 11, the upstream-side branch passage 22 may be divided into a first branch passage 22a and a second branch passage 22b at its upstream end so that the dividing line extends obliquely with respect to the vertical direction.

### Fourth Embodiment

The configuration of the EGR device according to the fourth embodiment is basically the same as the configuration of the EGR device according to the first embodiment, except for the following points. Therefore, the fourth embodiment of the present disclosure will be described below focusing on portions different from the first embodiment.

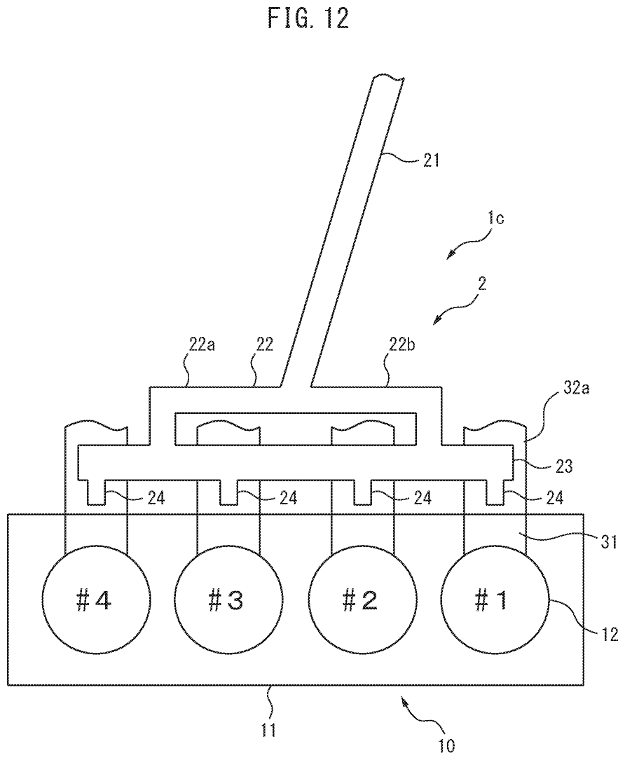

FIG. 12 is a diagram schematically showing a configuration of an EGR device 1c according to a fourth embodiment of the present disclosure. Similar to the first embodiment, the EGR device 1c includes an EGR passage 2, and the EGR passage 2 includes an exhaust gas inlet passage 21, an upstream-side branch passage 22, a downstream-side branch passage 23, and a plurality of EGR inlet pipes 24.

In the fourth embodiment, as shown in FIG. 12, the exhaust gas inlet passage 21 extends inclined with respect to the horizontal direction perpendicular to the cylinder arrangement direction and is connected to the upstream-side branch passage 22. The upstream-side branch passage 22 consists of a first branch passage 22a and a second branch passage 22b, and the first branch passage 22a and the second branch passage 22b extend in opposite directions to each other in the arrangement direction of the plurality of cylinders 12. That is, the first branch passage 22a extends in one direction (from the right to the left in FIG. 12) parallel to the arrangement direction of the plurality of cylinders 12, and the second branch passage 22b extends in the other direction (from the left to the right in FIG. 12) parallel to the arrangement direction of the plurality of cylinders 12. The first branch passage 22a and the second branch passage 22b communicate with each other, and condensed water can move between the first branch passage 22a and the second branch passage 22b.

As described above, the condensed water accumulated in the EGR passage 2 moves in the EGR passage 2 by the acceleration applied to the internal combustion engine 10. As shown in FIG. 12, the exhaust gas inlet passage 21 extends obliquely downward left from the upstream side toward the downstream side. Therefore, when the acceleration in the right direction in FIG. 12 is applied to the internal combustion engine 10, the condensed water in the exhaust gas inlet passage 21 moves from left to right and flows into the upstream-side branch passage 22 from the exhaust gas inlet passage 21 along the right wall surface of the exhaust gas inlet passage 21. The inflow to the upstream-side branch passage 22 of the condensed water is prevented by the component of the wall surface direction of the acceleration in the right direction.

On the other hand, in the upstream-side branch passage 22, the inflow of the condensed water in the first branch passage 22a and the second branch passage 22b to the downstream-side branch passage 23 is promoted by the acceleration in the right direction. Further, in the downstream-side branch passage 23, the inflow of the condensed water in the downstream-side branch passage 23 to the first cylinder #1 is promoted by the acceleration in the right direction.

Therefore, according to the configuration of the EGR device 1c, when the right direction acceleration is applied to the internal combustion engine 10, the inflow of the condensed water located in the exhaust gas inlet passage 21 to the first cylinder #1 is suppressed. Therefore, as compared with the case in which most of the condensate water in the exhaust gas inlet passage 21 flows into the first cylinder #1 by the acceleration in the right direction, it is possible to suppress the condensed water accumulated in the EGR passage 2 from flowing concentrated into a specific cylinder.

On the other hand, when the acceleration in the left direction is applied to the internal combustion engine 10 in FIG. 12, the condensed water in the exhaust gas inlet passage 21 moves from right to left and flows into the upstream-side branch passage 22 from the exhaust gas inlet passage 21 along the left wall surface of the exhaust gas inlet passage 21. At this time, the inflow to the upstream-side branch passage 22 of the condensed water is promoted by the component of the wall surface direction of the acceleration in the left direction. Further, in the upstream-side branch passage 22, the inflow of the condensate water in the first branch passage 22a and the second branch passage 22b to the downstream-side branch passage 23 is promoted by the acceleration in the left direction, and in the downstream-side branch passage 23, the inflow of the condensed water in the downstream-side branch passage 23 to the fourth cylinder #4 is promoted by the acceleration in the left direction. Therefore, according to the configuration of the EGR device 1c, when the left direction acceleration is applied to the internal combustion engine 10, the flow into the fourth cylinder #4 of the condensed water located in the exhaust gas inlet passage 21 is promoted.

That is, if the exhaust gas inlet passage 21 extends inclined from one side of the horizontal direction to the other side of the horizontal direction from the upstream side toward the downstream side, when the acceleration from one side of the horizontal direction to the other side of the horizontal direction is applied to the internal combustion engine 10, the inflow of condensed water to a specific cylinder is promoted. Therefore, in the fourth embodiment, the internal combustion engine 10 is mounted on the vehicle so that in the internal combustion engine 10, the acceleration from one side in the horizontal direction to the other side in the horizontal direction is smaller than the acceleration from the other side in the horizontal direction to one side in the horizontal direction when the vehicle is running. Thus, even when the acceleration from one side in the horizontal direction to the other side in the horizontal direction is applied to the internal combustion engine 10, it is possible to suppress the inflow of condensed water to a particular cylinder.

As shown in FIG. 12, in the EGR device 1c, the exhaust gas inlet passage 21 extends inclined from the horizontal right side to the horizontal direction left side from the upstream side toward the downstream side. In this case, the internal combustion engine 10 is mounted on the vehicle so that in the internal combustion engine 10, the acceleration from the horizontal direction right side to the horizontal direction left side is smaller than the acceleration from the horizontal direction left side to the horizontal direction right side when the vehicle is running. Thus, even when the acceleration from the horizontal right side to the horizontal direction left side is applied to the internal combustion engine 10, it is possible to suppress the inflow of condensed water to a particular cylinder.

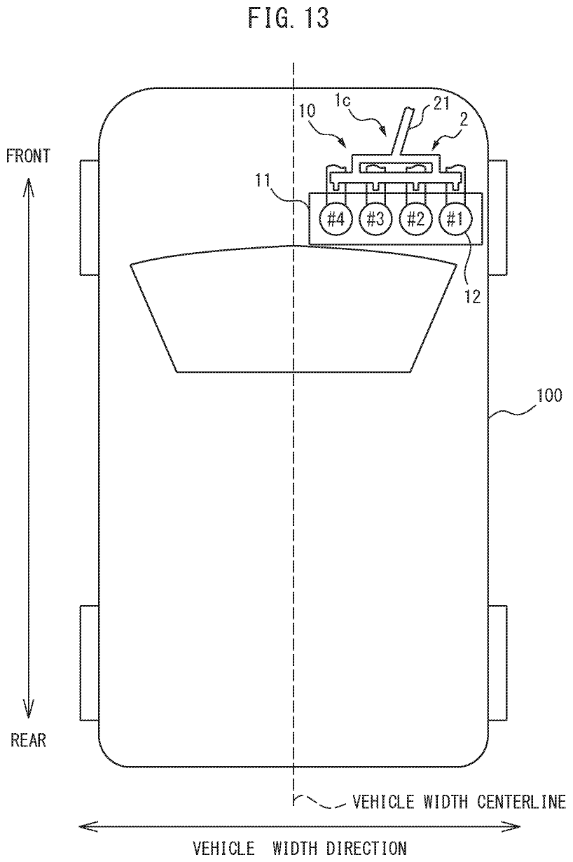

FIG. 13 is a diagram illustrating an example of a mounting position of the internal combustion engine 10 with respect to the vehicle 100. In the example of FIG. 13, the internal combustion engine 10 is mounted on the vehicle 100 so that the cylinder arrangement direction coincides with the vehicle width direction and the engine body 11 and the EGR passage 2 are positioned on the right side of the vehicle width centerline. In this case, the radius of rotation of the engine body 11 and the EGR passage 2 when the vehicle 100 is turned to the right is shorter than the radius of rotation of the engine body 11 and the EGR passage 2 when the vehicle 100 is turned to the left. Therefore, the acceleration from the horizontal direction right side to the horizontal direction left side applied to the internal combustion engine 10 when the vehicle 100 is turned to the right is smaller than the acceleration from the horizontal direction left side to the horizontal direction right side applied to the internal combustion engine 10 when the vehicle 100 is turned to the left.

Further, when the engine output is large, the amount of in-cylinder air increases, the combustion characteristics of the air-fuel mixture in the cylinder 12 is improved. Furthermore, when the engine output is large, the amount of EGR gas is reduced, the amount of condensed water supplied from the EGR passage 2 into the cylinder 12 is reduced. Therefore, when the engine output is large as in the acceleration of the vehicle, compared with when the engine output is small as in the deceleration of the vehicle, misfire caused by the condensed water in the EGR passage 2 is less likely to occur.

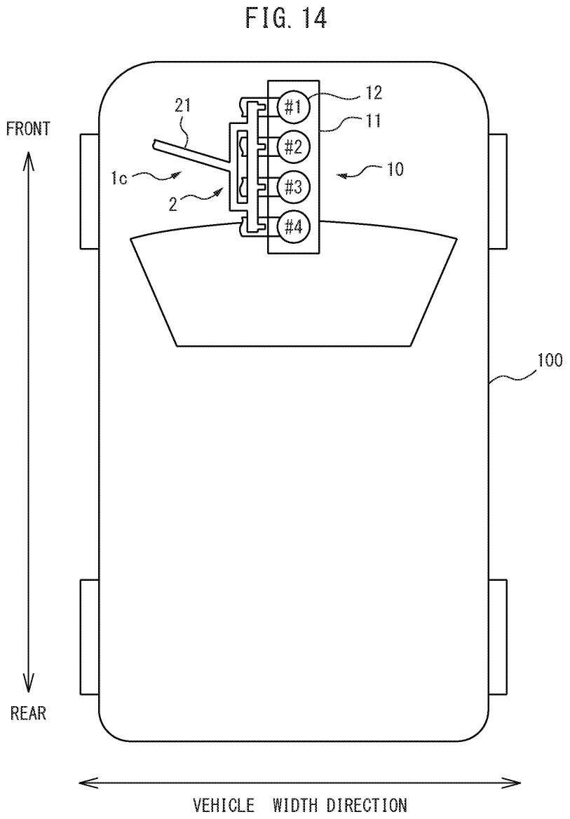

In view of this, as shown in FIG. 14, the internal combustion engine 10 may be mounted on the vehicle 100 so that the cylinder arrangement direction coincides with a direction perpendicular to the vehicle width direction, and the exhaust gas inlet passage 21 extends inclined in a direction (downward in FIG. 14) of acceleration applied to the internal combustion engine 10 by acceleration of the vehicle 100 from the upstream side toward the downstream side. Thus, even if the condensate water flows concentrated in a particular cylinder when the acceleration in the rear direction is applied to the internal combustion engine 10 by the acceleration of the vehicle 100, it is possible to suppress misfire due to condensed water. On the other hand, when the acceleration in the front direction is applied to the internal combustion engine 10 by the deceleration of the vehicle 100, it is possible to suppress the condensed water flows concentrated in a particular cylinder by the configuration of the exhaust gas inlet passage 21.

While preferred embodiments of the present disclosure have been described above, the present disclosure is not limited to these embodiments, and various modifications and changes may be made within the scope of the appended claims.

For example, the internal combustion engine 10 provided with the EGR device 1, la, 1b, 1c may be a compression-ignition internal combustion engine, such as a diesel engine. The internal combustion engine 10 may have other cylinder arrangements. That is, the internal combustion engine 10 may be a series 3-cylinder engine, a series 6-cylinder engine, a V-type 6-cylinder engine, a V-type 8-cylinder engine, or the like. When the internal combustion engine 10 is a V-type engine, a plurality of cylinders arranged in series in each bank corresponds to a plurality of cylinders connected in series in the horizontal direction.

Further, in the second embodiment, the upstream-side branch passage 22 may be divided into a first branch passage 22a and a second branch passage 22b at its upstream end so that the dividing line extend in the vertical direction. In the third embodiment, the upstream side branch passage 22 may be divided into the first branch passage 22a and the second branch passage 22b at the upstream side end thereof so that the dividing line extends in the horizontal direction. In these cases as well, it is possible to suppress the condensate water from moving between the first branch passage 22a and the second branch passage 22b when the acceleration in a direction parallel to the cylinder arrangement direction is applied to the internal combustion engine 10, and thus it is possible to suppress the condensed water accumulated in the EGR passage 2 from flowing into the specific cylinder concentrated.

### DESCRIPTION OF SYMBOLS

1, 1a, 1b, 1c EGR device
2 EGR passage
21 Exhaust gas inlet passage
22 Upstream-side branch passage
23 Downstream-side branch passage
24 EGR inlet pipe
10 Internal combustion engine
12 Cylinders
31 Intake ports
32 Intake manifold
32a Branch portions of the intake manifold

1. An EGR device provided in an internal combustion engine having a plurality of cylinders arranged in series in a horizontal direction and a plurality of intake branch passages connected to each of the plurality of cylinders, comprising:
a plurality of EGR inlet pipes connected to each of the plurality of intake branch passages;
an exhaust gas inlet passage conveying a portion of the exhaust gas as EGR gas;
an upstream-side branch passage in communication with the exhaust gas inlet passage and branching the EGR gas; and
a downstream-side branch passage distributing the EGR gas branched in the upstream-side branch passage to the plurality of EGR inlet pipes, wherein
the downstream-side branch passage extends in a direction parallel to an arrangement direction of the plurality of cylinders, and
at least one of the exhaust gas inlet passage and the upstream-side branch passage is configured to suppress flow to a downstream side of condensed water located upstream of the downstream-side branch passage when acceleration in a direction parallel to the arrangement direction is applied to the internal combustion engine.

2. The EGR device according to claim 1, wherein
the upstream-side branch passage comprises a first branch passage and a second branch passage, and
the first branch passage and the second branch passage are configured so that the condensed water does not move between the first branch passage and the second branch passage when an acceleration in a direction parallel to the arrangement direction is applied to the internal combustion engine.

3. The EGR device according to claim 2, wherein the first branch passage and the second branch passage are separated by a partition wall.

4. The EGR device according to claim 2, wherein the upstream-side branch passage is divided into the first branch passage and the second branch passage at an upstream end of the upstream-side branch passage.

5. The EGR device according to claim 4, wherein
the exhaust gas inlet passage extends from one side to an other side in a direction parallel to the arrangement direction from an upstream side toward a downstream side,
the upstream-side branch passage, at the upstream end, is divided into the first branch passage and the second branch passage so that the first branch passage is positioned vertically upward and the second branch passage is positioned vertically downward, and
the first branch passage extends from the one side to the other side from an upstream side toward a downstream side, and the second branch passage extends from the other side to the one side from an upstream side toward a downstream side.

6. The EGR device according to claim 5, wherein the upstream-side branch passage is divided into the first branch passage and the second branch passage at the upstream end such that a dividing line extends horizontally.

7. The EGR device according to claim 4, wherein
the exhaust gas inlet passage extends in a horizontal direction perpendicular to the arrangement direction,
the upstream-side branch passage, at the upstream end, is divided into the first branch passage and the second branch passage so that the first branch passage is positioned on one side in a horizontal direction and the second branch passage is positioned on an other side in the horizontal direction, and
the first branch passage extends from the one side to the other side from an upstream side toward a downstream side, and the second branch passage extends from the other side to the one side from an upstream side toward a downstream side.

8. The EGR device according to claim 7, wherein the upstream-side branch passage is divided into the first branch passage and the second branch passage at the upstream end such that a dividing line extends vertically,
The EGR device according to claim 1, wherein the exhaust-gas inlet passage extends obliquely with respect to a horizontal direction perpendicular to the arrangement direction.

10. The EGR device according to claim 9, wherein
the exhaust gas inlet passage extends obliquely from one side in a horizontal direction to the other side in the horizontal direction from an upstream side toward a downstream side, and
the internal combustion engine is mounted on a vehicle so that in the internal combustion engine, acceleration from the one side to the other side is smaller than the acceleration from the other side to the one side when the vehicle is running.

11. The EGR device according to claim 9, wherein the internal combustion engine is mounted on the vehicle so that the arrangement direction coincides with a direction perpendicular to a vehicle width direction and the exhaust gas inlet passage extends inclined in a direction of acceleration applied to the internal combustion engine by acceleration of a vehicle from an upstream side toward a downstream side.
